(19) United States
(12) Patent Application Publication
(10) Pub. No.: US 2017/0139118 A1
(43) Pub. Date: May 18, 2017

(54) BACKPLANE, BACKLIGHT MODULE AND DISPLAY DEVICE

(71) Applicant: Wuhan China Star Optoelectronics Technology Co., Ltd., Wuhan, Hubei (CN)

(72) Inventor: Gege ZHOU, Shenzhen, Guangdong (CN)

(73) Assignee: Wuhan China Star Optoelectronics Technology Co., Ltd., Wuhan, Hubei (CN)

(21) Appl. No.: 14/762,614

(22) PCT Filed: May 22, 2015
(86) PCT No.: PCT/CN2015/079577

§ 371 Date: Jul. 22, 2015

(30) Foreign Application Priority Data
Apr. 29, 2015 (CN) 201510216930.5

(51) Int. Cl. F21V 8/00; G02F 1/1333

(52) U.S. Cl. CPC G02B 6/0088; G02B 6/005; G02F 1/133308

(57) ABSTRACT

The invention provides a backplane and a backlight module provided with the backplane. The backlight module further includes a light guide plate and an optical film disposed on the light guide plate. The backplane includes a base plate and a side plate formed by bending an edge of the base plate, a connection location of the side plate and the base plate is provided with multiple positioning pieces, the multiple positioning pieces and the side plate are located at a same side of the base plate and each have an extending direction opposite to an extending direction of the side plate. The invention further provides a display device.

### CROSS-REFERENCE TO RELATED APPLICATION

This application claims the priority of Chinese Patent Application No. 201510216930.5, entitled “Backplane, Backlight Module and Display Device”, filed on Apr. 29, 2015, the disclosure of which is incorporated herein by reference in its entirety.

### BACKGROUND

Technical Field

The invention relates to the field of liquid crystal display technology, and particularly to a backplane, a backlight module and a display device.

Description of Related Art

Nowadays, liquid crystal display devices as display parts of electronic devices have been widely used in various electronic products. With the development of thin and lightweight of electronic products, borders of the electronic devices are designed to be more and more narrow. A backlight module is an important component of the liquid crystal display device, and thus the border of the backlight module is bound to be more and more narrow.

The backlight module of the prior art includes a backplane, a light guide plate disposed above the backplane, an optical film and a plastic frame which is used to fix and support the light guide plate and the optical film (it is generally that disposing positioning holes on the backplane to position the plastic frame). A display panel is located above a backlight source, light rays are evenly distributed after being reflected and diffused by the light guide plate and then are incident on the display panel after being diffused, mixed and converged by the optical film to thereby provide a light source for the display panel.

However, in order to realize a positioning between a backlight module of liquid crystal display and a terminal device, it is necessary to dispose a connecting plate and punch a screw hole on the backplane, and it is also needed to form positioning holes to ensure the assembling stability between the backplane and the plastic frame, in this way, the thickness of wall of the plastic frame is required to be much thick so as to ensure the quality, so that it is not easy to achieve the narrow border design and thereby the narrow boarder and thin development treads of the backlight module are affected as a result.

### SUMMARY

Accordingly, a technical problem to be solved by the invention is to provide a backplane and a backlight module, so as to realize a narrow border design and ensure an assembly quality of backlight module.

The invention further provides a display device.

In order to achieve the above-mentioned objectives, embodiments of the invention provide technical solutions as follows:

In particular, the invention provides a backplane. The backplane includes a base plate and a side plate formed by bending an edge of the base plate, a connection location of the side plate and the base plate is spacedly disposed with multiple positioning pieces, the multiple positioning pieces and the side plate are located at a same side of the base plate and each have an extending direction opposite to an extending direction of the side plate.

In an exemplary embodiment, the multiple positioning pieces each are formed by partially cutting a location of the base plate near the side plate along a direction toward the side plate and then bending the cut portion along a direction opposite to the extending direction of the side plate, a notch being formed at the location of the base plate after the positioning piece is bent along the direction opposite to the extending direction of the side plate.

In an exemplary embodiment, each of the positioning pieces is provided with a positioning hole.

In an exemplary embodiment, the backplane is formed by cutting a metal plate.

The invention further provides a backlight module. The backlight module includes a backplane, a light guide plate and an optical film disposed on the light guide plate. The backplane includes a base plate and a side plate formed by bending an edge of the base plate, a connection location of the side plate and the base plate is spacedly disposed with multiple positioning pieces, the multiple positioning pieces and the side plate are located at a same side of the base plate and each have an extending direction opposite to an extending direction of the side plate, the light guide plate is disposed on the base plate.

In an exemplary embodiment, the backlight module further includes a positioning adhesive, the positioning adhesive is located at a periphery of the optical film to adhere and fix the optical film with the side plate.

In an exemplary embodiment, the multiple positioning pieces each are formed by partly cutting a location of the base plate near the side plate along a direction toward the side plate and then bending the cut portion along a direction opposite to the extending direction of the side plate, and a notch correspondingly being formed at the location of the base plate near the side plate after the positioning piece is bent along the direction opposite to the extending direction of the side plate.

The invention further provides a display device. The display device includes a backlight module, a liquid crystal panel and a shell, the liquid crystal panel is disposed on the backlight module and installed in the shell together with the backlight module, the shell is disposed with a positioning part. The backlight module includes a backplane, a light guide plate and an optical film disposed on the light guide plate. The backplane includes a base plate and a side plate formed by bending an edge of the base plate, a connection location of the side plate and the base plate is spacedly disposed with multiple positioning pieces, the multiple positioning pieces and the side plate are located at a same side of the base plate and each have an extending direction opposite to an extending direction of the side plate, the light guide plate is disposed on the base plate, the positioning pieces of the backlight module are securely connected with the positioning part.

In an exemplary embodiment, the positioning pieces each are disposed with a positioning hole, the positioning part is a border of the shell, the positioning part is provided with connecting holes, and the positioning holes are connected with the connecting holes by screws.

In an exemplary embodiment, the multiple positioning pieces each are formed by partly cutting a location of the base plate near the side plate along a direction toward the side plate and then bending the cut portion along a direction opposite to the extending direction of the side plate, and a notch being formed at the location of the base plate near the side plate after the positioning piece is bent along the direction opposite to the extending direction of the side plate.

The backlight module provided by the embodiments of the invention omits/eliminates the plastic frame and disposes one side plate and multiple positioning pieces at a same side of the base plate, the positioning pieces can satisfy the assembly of the backplane with the display device while omitting the plastic frame, and thus it is no longer needed to dispose additional positioning structure for the backplane and the plastic frame. Moreover, the side plate can ensure hardness quality of the backlight module as well as can reduce the border thickness of the backlight module. As a result, a narrow border effect can be achieved.

### BRIEF DESCRIPTION OF THE DRAWINGS

In order to more clearly illustrate technical solutions of the invention, drawings will be used in embodiments will be made a brief description in the following, and apparently, the drawings in the below description only are some embodiments of the invention, for those ordinary skill in the art, other drawings can be obtained based on these illustrated drawings under the premise of without creative efforts.

FIG. 1 is a structural schematic view of a backplane of a backlight module of the invention.

FIG. 2 is a cross-sectional schematic view of the backlight module shown in FIG. 1.

### DETAILED DESCRIPTION OF EMBODIMENTS

In the following, with reference to accompanying drawings of embodiments of the invention, technical solutions in the embodiments of the invention will be clearly and completely described.

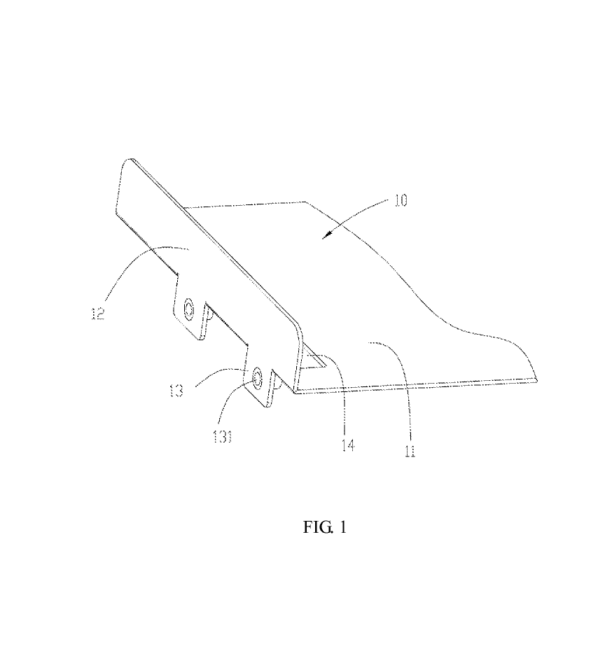

Referring to FIG. 1, preferred embodiments of the invention provide a backplane and a backlight module provided with the backplane. The backplane is used to carry/support components of the backlight module such as a light guide plate. The backplane 10 includes a base plate 11 and side plates 12 formed by bending edges of the base plate 11. Multiple (i.e., more than one) positioning pieces are spacedly disposed at a connection location of each side plate 12 with the base plate 11, the multiple positioning pieces 13 and the side plate 12 are located at a same side of the base plate 11 but have an extending direction (e.g., downward direction) opposite to an extending direction (e.g., upward direction) of the side plate 12.

In this embodiment, the backplane 10 is formed by cutting a metal plate. The base plate 11 is a rectangular plate. The side plates 12 respectively are located at opposite ends of the base plate 11.

The multiple positioning pieces 13 are rectangular pieces. Each of the positioning pieces 13 is formed by partially cutting a location of the base plate 11 near the side plate 12 along a direction toward the side plate 12 and then bending the cut portion along a direction opposite to the extending direction of the side plate 12. At the same time, a notch 14 is simultaneously formed at the location of the base plate 11 near the side plate 12 after the positioning piece 13 is bent along the opposite direction of the extending direction of the side plate 12. More specifically, on the base plate 11, by cutting two parallel cut marks along a direction perpendicular to the connection portion of the side plate 12 with the base plate 11 and far away from the side plate 12 and then cutting one cut mark at a location connecting the two cut marks to thereby form a rectangle, and further bending the cut portion surrounded by the cut marks toward a direction opposite to the extending direction of the side plate 12, one positioning piece 13 is formed as a result, and one notch 14 is simultaneously formed on the base plate 11.

Furthermore, each the positioning piece 13 is formed with a positioning hole 131. The positioning hole 131 is used to fix the backplane to other component such as a shell of an electronic device.

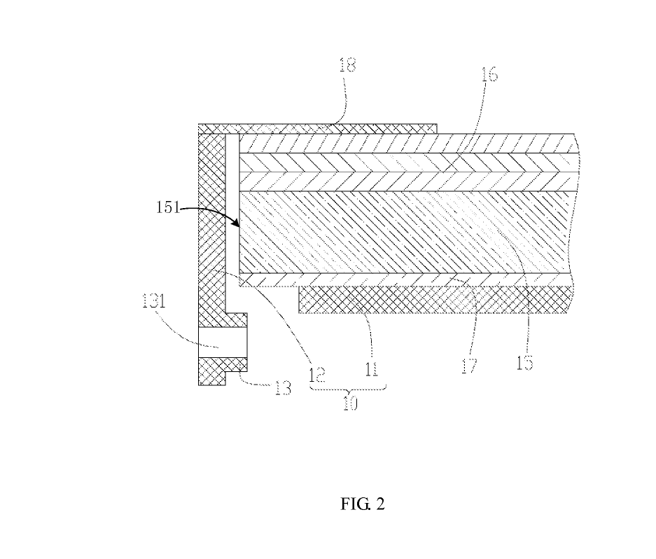

Referring to FIG. 2, the backlight module of the invention includes the backplane 10, a light guide plate 15 and an optical film 16 disposed on the light guide plate 15. The light guide plate 15 is disposed on the base plate 11, a periphery of the light guide plate 15 and the side plate 12 are oppositely disposed. In this embodiment, the light guide plate 15 has a light-incident surface 151 and a light-emitting surface connected with (i.e., neighboring with) the light-incident surface 151. A side of the light-incident surface 15 is disposed with a light source (not shown in the drawing). The optical film 16 is installed on the light-emitting surface. Furthermore, the backlight module further includes a positioning adhesive 18, the positioning adhesive 18 is located at the periphery of the optical film 16 to adhere and fix the optical film 16 with the side plate 12. In this embodiment, the positioning adhesive 18 is a double-sided adhesive. The backlight module omits/eliminates the plastic frame of the prior art and dispose one side plate and multiple positioning pieces at a same side of the base plate of the backplane, the positioning pieces can satisfy the assembly of the backplane with the display device while omitting the plastic frame and thus it is no longer needed to dispose additional positioning structure for the backplane and the plastic frame. Moreover, the side plate can ensure hardness quality of the backlight module as well as can reduce the border thickness of the backlight module. As a result, a narrow border effect is achieved.

Furthermore, a reflector piece 17 is disposed between the light guide plate 15 and the base plate 11. The reflector piece 17 is used for assisting the light guide plate to guide light rays fully to exit from the light-emitting surface.

The invention further involves a display device. The display device includes a backlight module, a liquid crystal panel and a shell (not shown in the drawing), the liquid crystal panel is disposed on the backlight module and installed in the shell together with the backlight module. The shell is disposed with a positioning part. The light guide plate is disposed on the base plate, the positioning pieces of the backlight module are fixedly/securely connected with the positioning part. In this embodiment, the positioning part is a border of the shell, the positioning part is disposed with connecting holes, and the connecting holes are connected with the corresponding positioning holes by screws. The connecting holes are threaded blind holes disposed in the border. The liquid crystal panel is located above a backlight source, light rays are evenly distributed after being reflected and diffused by the light guide plate and then are incident on the liquid crystal panel after being diffused, mixed and converged by the optical film, to thereby provide a light source for the liquid crystal panel.

The foregoing discussion only is some preferred embodiments of the invention, it should be noted that, for ordinary skill in the art, under the premise of without departing from the principle of the invention, several modification and variations can be made, and these modifications and variations should be included in the protection scope of the invention.

What is claimed is:

1. A backplane comprising a base plate and a side plate formed by bending an edge of the base plate; wherein a connection location of the side plate and the base plate is provided with a plurality of positioning pieces spaced from each other, the plurality of positioning pieces and the side plate are located at a same side of the base plate and each have an extending direction opposite to an extending direction of the side plate.

2. The backplane as claimed in claim 1, wherein the plurality of positioning pieces each are formed by partially cutting a location of the base plate near the side plate along a direction toward the side plate and then bending along a direction opposite to the extending direction of the side plate, a notch being formed at the location of the base plate near the side plate after the positioning piece is bended toward the direction opposite to the extending direction of the side plate.

3. The backplane as claimed in claim 2, wherein the plurality of positioning pieces each are disposed with a positioning hole.

4. The backplane as claimed in claim 1, wherein the backplane is formed by cutting a metal plate.

5. A backlight module comprising a backplane, a light guide plate and an optical film disposed on the light guide plate; wherein the backplane comprises a base plate and a side plate formed by bending an edge of the base plate, a connection location of the side plate and the base plate is provided with a plurality of positioning pieces spaced from each other, the plurality of positioning pieces and the side plate are located at a same side of the base plate and each have an extending direction opposite to an extending direction of the side plate, the light guide plate is disposed on the base plate.

6. The backlight module as claimed in claim 5, further comprising a positioning adhesive, the positioning adhesive is located at a periphery of the optical film to adhere and fix the optical film with the side plate.

7. The backlight module as claimed in claim 6, wherein the plurality of positioning pieces each are formed by partly cutting a location of the base plate near the side plate along a direction toward the side plate and then bending along a direction opposite to the extending direction of the side plate, and a notch being formed at the location of the base plate near the side plate after the positioning piece is bent along the direction opposite to the extending direction of the side plate.

8. A display device comprising a backlight module, a liquid crystal panel and a shell; wherein the liquid crystal panel is disposed on the backlight module and installed in the shell together with the backlight module, the shell is disposed with a positioning part; the backlight module comprises a backplane, a light guide plate and an optical film disposed on the light guide plate, the backplane comprises a base plate and a side plate formed by bending an edge of the base plate, a connection location of the side plate and the base plate is provided with a plurality of positioning pieces spaced from each other, the plurality of positioning pieces and the side plate are located at a same side of the base plate and each have an extending direction opposite to an extending direction of the side plate; the light guide plate is disposed on the base plate, the plurality of positioning pieces of the backlight module are securely connected with the positioning part.

9. The display device as claimed in claim 8, wherein the plurality of positioning pieces each are provided with a positioning hole, the positioning part is a border of the shell, the positioning part is provided with connecting holes, and the positioning holes are connected with the connecting holes by screws.

10. The display device as claimed in claim 8, wherein the plurality of positioning pieces each are formed by partly cutting a location of the base plate near the side plate along a direction toward the side plate and then bending along a direction opposite to the extending direction of the side plate, and a notch being formed at the location of the base plate near the side plate after the positioning piece is bent along the direction opposite to the extending direction of the side plate.
